(19) United States
(12) Patent Application Publication
(10) Pub. No.: US 2003/0014303 A1
(43) Pub. Date: Jan. 16, 2003

(54) Announcement of new musicals, new music and other creative works

(76) Inventor: Mary E. Goulet, Falls Church, VA (US)

Correspondence Address: MARY E. GOULET, 7025-H HAYCOCK ROAD, FALLS CHURCH, VA, 22043, US

(21) Appl. No.: 09/902,769

(22) Filed: Jul. 12, 2001

(51) Int. Cl. G06F 17/60

(52) U.S. Cl. 705/14

(57) ABSTRACT

Methods and products are provided to promote a creative-work (such as a musical theater show, such as “Worlds Away”). An Internet site is used, along with distributing a permanent non-paper announcement item (such as a beach towel). Worldsawaymusical.com is an example of such an Internet site.

### DESCRIPTION

### FIELD OF THE INVENTION

The invention generally relates to promotion of new creative works, and especially to announcement and publicity for new musical works such as musicals.

### BACKGROUND OF THE INVENTION

Historically, promoting new music and new musical works has been difficult and expensive. Establishing a base of paying customers for the music (and music-related products) continues to be a difficult, and often prohibitive, problem for musicians. Obtaining access to audiences historically has involved marketing, promotion, and distribution channels that do not necessarily open themselves to a new composer or musician who might be interested in using such existing channels.

At the same time that musicians want, and struggle, to reach and build audiences of interested, paying customers, for certain music and/or an upcoming event, there are individuals who may be interested but who are unaware of the music or event. Publicity for the music or the event may never have reached the individual. Or, in some cases, publicity may reach an individual but not catalyze a purchase, such as with conventional ticket sales systems that require physical visits to a sales location, or offer only limited telephone service hours.

The problems of audience-building, promotion, advertising and distribution are not limited to musicians, but also are faced by other creative artists, such as painters, writers, fashion designers, etc. New creative works face different and further challenges compared to many non-creative items. For example, a new contact lens cleaner may be promoted by giving away free initial samples, with the expectation of generating sales from the customer to whom the sample was given when the sample is completed. Music, art and literary works have not seemed to be particularly suited to such promotion techniques.

In recent years, musicians and others have come to post information about themselves and their work on the World Wide Web, or Internet, which in recent years has been increasing in popular usage, and offers a medium for musicians and non-musicians alike to inform potential customers about themselves, 24-hours-a-day. However, the Internet has been far from a perfect or complete solution to how musicians and artists may promote their new creative works and establish an audience, and actually has introduced certain problems, such as on-line unauthorized downloading of music that may erode paid purchases of creative work. Also, content on the Internet is vast, posting a website alone is unlikely to result in many, if any, website visitors. A new, unknown creative artist such as a musician who posts a website and merely waits for random searches is unlikely to be reached by many people. Existing options that exist for attracting visitors to a website either are not seen as particularly effective or generally are so costly as to make them impractical.

The Internet may present potential for building and serving a customer base in creative areas such as music, but the potential has not been realized.

### SUMMARY OF THE INVENTION

It therefore is an object of this invention to provide products and methods which exploit the advantageous features of an Internet website.

In order to accomplish these and other objects of the invention, the present invention in a preferred embodiment provides a method of promoting a creative work, comprising: for a to-be-promoted creative work, posting for public access an Internet site relating to the creative work; and after posting the site, optionally updating and/or revising the site one or more times; and, after posting the site, distributing a permanent non-paper announcement item for the site. In the inventive methods, preferably the announcement item is reusable. Also, it is preferred that the permanent announcement item is observable by others besides a person to whom the item was directly distributed. In a particularly preferred embodiment, the permanent non-paper announcement item may comprise a beach towel including the Internet site address.

Another preferred embodiment of the invention provides a creative-work promotional beach towel, comprising: a beach towel including an Internet domain name relating to a creative-work, wherein the name represents a publically accessible active Internet website on which appears content relating to the creative-work. beach towels are provided. For a beach towel according to the invention, preferably the Internet site address is embroidered onto the towel.

In the inventive methods and products, the creative-work may be musical, such as a musical theater show (which may be a new musical show). When the creative-work is musical, preferably the site includes, either as posted or as updated/revised, at least one musical sample clip.

In the inventive methods and products, preferably the site includes a purchasing feature. The purchasing feature may be for purchase of tickets to attend a performance (such as an upcoming new musical theater work) and/or for purchase of the creative-work.

### BRIEF DESCRIPTION OF THE DRAWINGS

The foregoing and other objects, aspects and advantages will be better understood from the following detailed description of the preferred embodiments of the invention with reference to the drawings, in which:

FIGS. 1(a) and (b) are schematics of creative-work promoting methods according to the present invention.

FIG. 2 is a top view of a beach towel according to the present invention.

### DETAILED DESCRIPTION OF THE PREFERRED EMBODIMENTS OF THE INVENTION

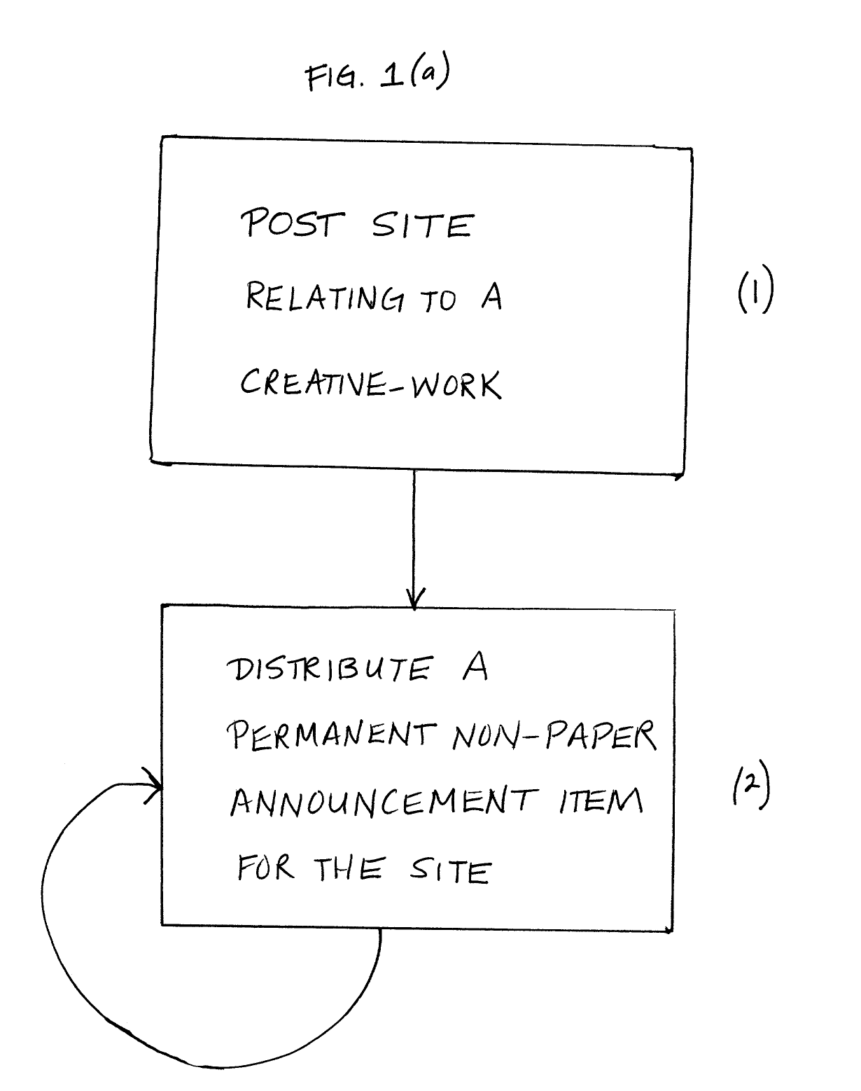

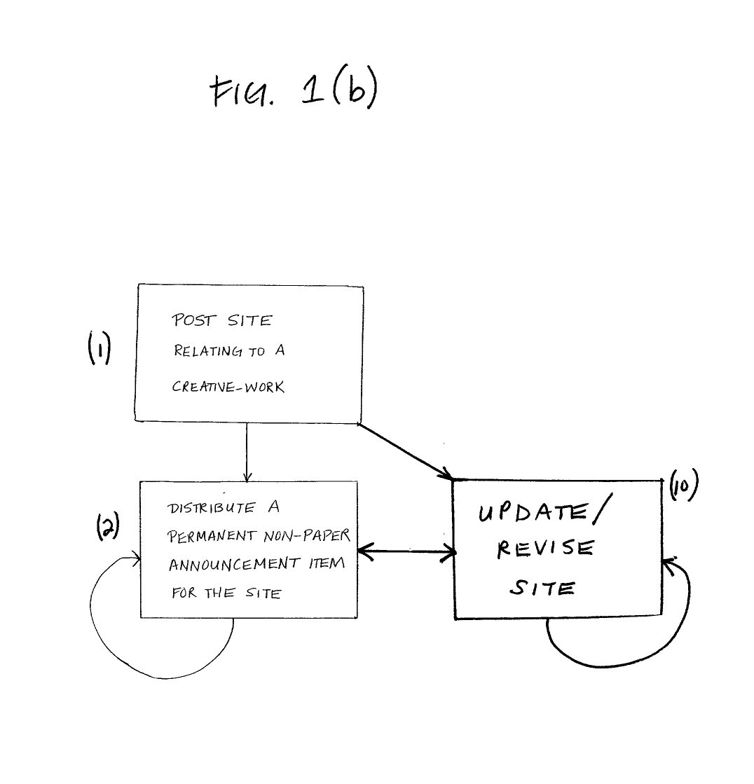

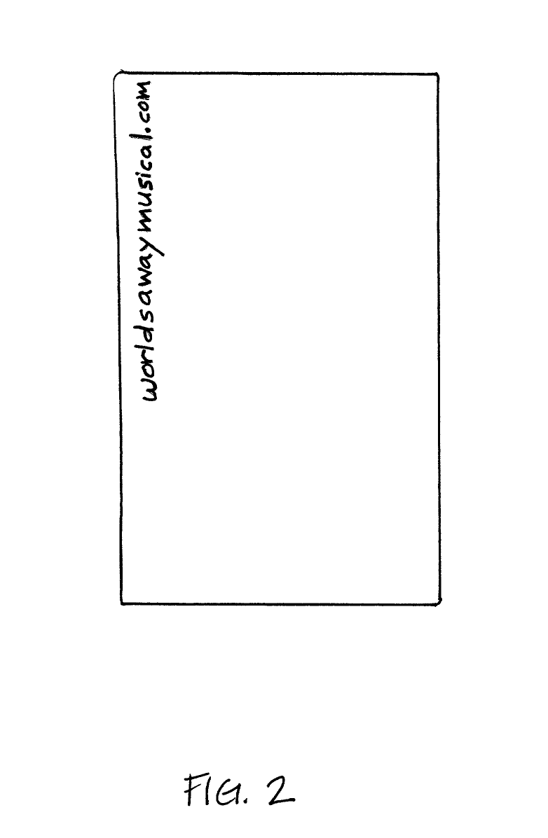

In preferred embodiments, such as those shown in FIGS. 1(a) and 1(b), the invention provides methods of promoting a creative work. A creative work to be promoted may be, without limitation, any musical work (such as a song, a musical theater show, etc.), any literary work (such as a book, etc.), any dramatic work (such as a play, etc.), any artistic work (such as a painting, a painting style, etc.). A creative work includes single works (such as a musical theater show, a song, an album, etc.) and series (such as songs or albums by the same composer).

As shown in FIG. 1, such an inventive method preferably includes, for a to-be-promoted creative work, posting for public access an Internet site relating to the creative work (1). Preferably the domain name relates closely to the to-be-promoted creative work, and is easy to remember. Also preferably the domain name avoids character combinations that when viewed in print or other visible form may be difficult to discern or reproduce (e.g., substituting a zero for a letter “O” in a word, such as “w0rd”; difficult-to-spell words; long strings of characters that do not spell a word).

As shown in FIG. 1, the inventive method provides for, after posting the site, distributing a permanent non-paper announcement item for the site (2). A permanent non-paper announcement item according to the invention includes any non-paper item intended for more than a single use, such as a beach towel, ceramic mug, luggage, article of clothing, jewelry, accessory, sunglasses, hat, etc., on which is included the Internet site address. Preferably, the permanent announcement item is observable by others besides a person to whom the item was directly distributed. Where the permanent announcement item comprises a towel or clothing, most preferably, the Internet site address is embroidered onto the towel for greater permanence.

In the case of a creative work that is a show (such as a musical theater show), which may spend years in development and which, once staged, generally is in a limited geographic area at one time, the permanent announcement item is particularly preferred to be an item which the user will keep for several years. Thus, the user is reminded from time to time to refer back to the website and can be updated about the show. For a show, preferably the website as posted or as revised includes a ticket purchasing feature.

It will be appreciated that distribution of a permanent announcement item as provided by the invention does not exclude the additional distribution of other announcement items, such as non-permanent paper announcement items. Preferably, non-permanent announcement items (such as business cards, invitations, stationery, note cards, balloons, etc.) are used in addition to the permanent announcement items.

With reference to FIG. 1(b), in an exemplary embodiment of the invention, the inventive method of FIG. 1(a) further includes, after posting the site, updating and/or revising the site one or more times (10). Such updating and/or revising of the site preferably includes changes and additions designed to provide new material of interest to returning site visitors. Preferably, the site updating and/or revising occurs more frequently than semi-annually, and more preferably, more frequently than quarterly, with updating as often as possible (such as weekly) being most preferred.

Where the creative work is musical (such as a musical theater show or a song), optionally, the site includes, either as posted or as updated/revised, at least one musical sample clip. Including a musical sample clip is preferred, but not required. As a sample clip, preferably less than an entire song is used, such as the first 30 seconds. Preferably the entire song is not used as the sample clip, since some visitors may download the musical sample and including the entire song may be more likely to interfere with achieving paid sales. Where a sample clip is included, the site may include a statement informing someone listening to the sample clip how to find a full recorded version and/or a full live version. Also, the site may includes a statement that the musical sample clip due to equipment and/or system constraints is of somewhat compromised quality compared to the full recorded version and/or the full live version. When a musical sample clip is included on the site, preferably the inventive method includes filing a copyright application relating to the musical sample clip before the musical sample clip is included on the site.

### EXAMPLE 1

For a new musical, “Worlds Away”, the domain name http://www.worldsawaymusical.com was obtained from Network Solutions Inc. A first-version website with text was posted to the public, and subsequently revised and updated, such as by changing the graphics, adding pages, including pictures, including information about upcoming activity, including information about where to purchase a CD, etc. After the http://www.worldsawaymusical.com website went on line, beach towels were made (by High Peak Sportswear, Lynchburg, Va.) on which were printed worldsawaymusical.com. The worldsawaymusical.com beach towels were distributed to attendees at a CD release party, buyers at record stores, radio stations, store owners, theater personnel, and others.

### EXAMPLE 2

For the new “Worlds Away” musical of Example 1, a “contact us” screen and function was established on the worldsawaymusical.com website. Sample clips of songs (for which copyright applications had been filed) were included on the worldsawaymusical.com website. Written material was sent (such as by U.S. postal mail) advising recipients that they could get a free “Worlds Away” beach towel by emailing worldsawaymusical.com. Email responses via the worldsawaymusical.com website were received, such as from radio stations, and beach towels were sent to the requesters. Thus, the requesters were introduced to the worldsawaymusical.com website and to the tunes from the upcoming “Worlds Away” musical.

While the invention has been described in terms of its preferred embodiments, those skilled in the art will recognize that the invention can be practiced with modification within the spirit and scope of the appended claims.

I claim:

1. A method of promoting a creative work, comprising:
for a to-be-promoted creative work, posting for public access an Internet site relating to the creative work, and after posting the site, optionally updating and/or revising the site one or more times; and,
after posting the site, distributing a permanent non-paper announcement item for the site.

2. The method of claim 1, wherein the permanent non-paper announcement item comprises a beach towel including the Internet site address.

3. The method of claim 1, wherein the creative work is musical.

4. The method of claim 3, wherein the musical creative work is a new musical theater work.

5. The method of claim 4, wherein the site includes a ticket purchasing feature for the new musical theater work.

6. The method of claim 1, wherein the announcement item is reusable.

7. The method of claim 1, wherein the permanent announcement item is observable by others besides a person to whom the item was directly distributed.

8. The method of claim 2, wherein the Internet site address is embroidered onto the towel.

9. The method of claim 1, wherein the site includes, either as posted or as updated/revised, at least one musical sample clip.

10. The method of claim 9, wherein the site includes a statement informing someone listening to the sample clip how to find a full recorded version and/or a full live version.

11. The method of claim 10, wherein the site includes a statement that the musical sample clip due to equipment and/or system constraints is of somewhat compromised quality compared to the full recorded version and/or the full live version.

12. The method of claim 1, wherein the site updating and/or revising occurs more frequently than quarterly.

13. The method of claim 9, including filing a copyright application relating to the musical sample clip before the musical sample clip is included on the site.

14. A creative-work promotional beach towel, comprising:
a beach towel including an Internet domain name relating to a creative-work, wherein the name represents a publically accessible active Internet website on which appears content relating to the creative-work.

15. The beach towel of claim 14, wherein the creative-work is a musical theater show.

16. The beach towel of claim 14, wherein the name is embroidered.

17. The beach towel of claim 15, wherein the Internet website includes at least one song clip of a tune from the show.

18. The beach towel of claim 15, wherein the Internet website includes a ticket purchasing feature.

19. The beach towel of claim 14, wherein the Internet website includes a purchasing feature.

20. The beach towel of claim 19, wherein the purchasing feature is for purchase of tickets to attend a performance and/or for purchase of the creative-work.
